(19) United States
(12) Patent Application Publication
(10) Pub. No.: US 2012/0146392 A1
(43) Pub. Date: Jun. 14, 2012

(54) AUTOMOTIVE WHEEL

(75) Inventor: Kazuo Hamada, Aichi (JP)

(73) Assignee: Central Motor Wheel Co., Ltd., Aichi (JP)

(21) Appl. No.: 13/391,469

(22) PCT Filed: Sep. 9, 2009
(86) PCT No.: PCT/JP2009/065729

§ 371 Date: Feb. 21, 2012

(51) Int. Cl. B60C 29/02

(52) U.S. Cl. 301/5.24

(57) ABSTRACT

In an automotive wheel, a well recessed portion that is recessed in the back-side direction along a well bottom portion forming a well of a wheel rim is formed at a portion of a back-side well wall portion of the well opposite a valve hole. Thus, vibration generated by the centrifugal force of an air valve with a pneumatic pressure detection device while an automobile is running can be suppressed by the effect due to the shape of the well recessed portion, and the operation stability, the riding comfort, and so forth of the automobile can be improved. In another automotive wheel, a well recessed portion that is recessed in the surface-side direction along a well bottom portion forming a well of a wheel rim is formed at a portion of a surface-side well wall portion forming the well at which a valve hole is formed such that a surface-side portion of a pneumatic pressure detection device of an air valve with a pneumatic pressure detection device is fitted in the well recessed portion. Also in this case, the same effect can be achieved.

### FIELD OF THE INVENTION

The present invention relates to an automotive wheel including a wheel disc to be coupled to an axle and a wheel rim that supports a tire.

### BACKGROUND

Among automotive wheels, there are so-called two-piece wheels in which a generally cylindrical wheel rim and a generally disc-like wheel disc are fitted and welded to each other. The wheel rim is generally shaped by curving a rectangular metal plate into a cylinder body and subjecting the cylinder body to rolling in which the cylinder body is pressed by predetermined dies from the inside and the outside. The wheel disc is generally shaped by subjecting a generally square metal plate to pressing. The wheel rim and the wheel disc which are shaped separately from each other are welded to be integrated with each other to obtain a two-piece automotive wheel.

The wheel rim includes surface-side and back-side bead seats that support beads of a tire, and a groove-shaped well formed circumferentially between the surface-side and back-side bead seats. The well is formed by an annular well bottom portion, and surface-side and back-side well wall portions formed continuously with inclination to extend in the outward direction from the surface-side and back-side ends, respectively, of the well bottom portion. A valve hole for attachment of an air valve is provided in the surface-side well wall portion.

The pneumatic pressure of a tire is one of important elements for maintaining various performances of the automobile, such as the running performance, the safety, and the durability, at desired levels. Thus, it is requested to install a pneumatic pressure detection device that detects the pneumatic pressure of a tire. A pneumatic pressure detection device integrated with an air valve (hereinafter referred to as an “air valve with a pneumatic pressure detection device”) is proposed in JP-A-2001-174357(“JP '357”), for example. A valve portion of the air valve with a pneumatic pressure detection device is fixed to a valve hole of the automotive wheel so that the pneumatic pressure detection device is disposed in the well.

### SUMMARY OF THE INVENTION

The air valve with a pneumatic pressure detection device includes a pneumatic pressure detection device incorporating a circuit, a battery, and so forth for detecting the pneumatic pressure, and thus is heavier than a normal air valve (air valve alone). Therefore, an automotive wheel equipped with the air valve with a pneumatic pressure detection device is locally heavy around the valve hole. When the automotive wheel is rotated, a portion surrounding the valve hole is elastically deformed in the outward direction by the centrifugal force generated by the own weight of the air valve with a pneumatic pressure detection device, which tends to increase vibration of the automotive wheel. If vibration is increased while the automobile is running, the operation stability, the riding comfort, and no forth of the automobile may be reduced. Therefore, it is desired to reduce such vibration as much as possible.

The present invention proposes an automotive wheel that can suppress vibration generated by the own weight of un air valve with a pneumatic pressure detection device mounted to the automotive wheel.

A first aspect of the present invention provides an automotive wheel including: a wheel rim including surface-side and back-side bead seats that support beads of a tire, and a groove-shaped well formed circumferentially between the surface-side and back-side bead seats; and a wheel disc to be coupled to an axle, the well of the wheel rim being formed by an annular well bottom portion, and surface-side and back-side well wall portions thrilled continuously with inclination to extend in a surface-side-back-side direction from surface-side and back-side ends, respectively, of the well bottom portion, and an air valve with a pneumatic pressure detection device being mounted to a valve hole formed in the surface-side well wall portion with the pneumatic pressure detection device disposed in the well, in which a well recessed portion that is recessed in a back-side direction along the well bottom portion is formed at a portion of the back-side well wall portion of the well opposite the valve hole.

The results of a detailed examination of vibration generated. during rotation of the automotive wheel configured in accordance with the related art discussed above with an air valve with a pneumatic pressure detection device mounted to a valve hole formed in a surface-side well wall portion of a well will be described. The air valve with a pneumatic pressure detection device is normally mounted to the automotive wheel by inserting a valve portion through the valve hole to fix the valve portion to a portion surrounding the valve hole using a nut or the like. In the automotive wheel, the air valve with a pneumatic pressure detection device is directly supported by the surface-side well wall portion in which the valve hole is formed. In the two-piece automotive wheel discussed above, the well of the wheel rim is formed by an annular well bottom portion, and surface-side and back-side well wall portions formed continuously with inclination to extend in the surface-side-back-side direction from the surface-side and back-side ends, respectively, of the well bottom portion. Therefore, the surface-side well wall portion which supports the air valve with a pneumatic pressure detection device is inclined in the surface-side direction with respect to the radial direction of the automotive wheel. Since the surface-side well wall portion to which the air valve with a pneumatic pressure detection device is fixed is formed with inclination, the surface-side well wall portion may be easily elastically deformed in the outward direction, with a point at the surface-side end of the surface-side well wall portion serving as the fulcrum, by the centrifugal force generated by the own weight of the air valve with a pneumatic pressure detection device during rotation of the automotive wheel. That is, it is inferred that vibration of the automotive wheel may be easily increased while the automobile is running by the effect due to the shape of the surface-side well wall portion forming the well.

The present invention is achieved by the inventor through diligent studies based on thorough research. In the automotive wheel according to the present invention, the rigidity of a portion surrounding the valve hole can be improved by the effect due to the shape of the well recessed portion formed at a position opposite the valve hole. This enhances the effect of suppressing elastic deformation in the outward direction caused in the portion surrounding the valve hole by the own weight of the air valve with a pneumatic pressure detection device. Thus, vibration generated by rotation of the automotive wheel equipped with the air valve with a pneumatic pressure detection device is suppressed to provide excellent operation stability, riding comfort, and so forth.

As shown in FIGS. 3 and 4, for example, a well recessed portion 31 formed in a back-side well wall portion 18b is formed by an extended bottom portion 32 extended in the back-side direction from a well bottom portion 17, an inclined portion 33 inclined in the back-side direction from the back-side end of the extended bottom portion 32, and side wall portions 34, 34 that rise up in the outward direction from both side ends of the extended bottom portion 32. The side wall portions 34, 34 of the well recessed portion 31 are provided to extend along the surface-side-back-side direction, and thus can improve the rigidity in the inward-outward direction. With such a configuration, elastic deformation in the outward direction caused in a portion of the surface-side well wall portion 18a surrounding the valve hole 19 by the centrifugal force of an air valve 100 with a pneumatic pressure detection device during rotation of an automotive wheel 1 can be suppressed by the rigidity improving effect of the side wall portions 34, 34 of the well recessed portion 31 provided opposite the valve hole 19. Thus, vibration generated in the automotive wheel while the automobile is running as described above can be suppressed.

In the configuration according to the present invention, the well recessed portion formed in the back-side well wall portion is preferably formed to have substantially the same circumferential width as that of the pneumatic pressure detection device of the air valve with a pneumatic pressure detection device. That is, the well recessed portion is preferably provided to face the pneumatic pressure detection device disposed in the well. With such a configuration, the side wall portions of the well recessed portion are formed along the side ends of the pneumatic pressure detection device in the circumferential direction, which farther improves the effect of suppressing elastic deformation in the outward direction caused in the portion surrounding the valve hole by the own weight of the air valve with a pneumatic pressure detection device.

In the automobile wheel discussed above, the well recessed portion formed in the back-side well wall portion of the well may be formed such that a back-side portion of the pneumatic pressure detection device of the air valve with a pneumatic pressure detection device can be disposed in the well recessed portion.

In such a configuration, the circumferential width of the well recessed portion is set such that the pneumatic pressure detection device of the air valve with a pneumatic pressure detection device can be disposed in the well recessed portion. Preferably, the side wall portions forming the well recessed portion and both side ends of the pneumatic pressure detection device are positioned in proximity to each other in the circumferential direction. This further improves the effect of suppressing elastic deformation in the outward direction caused in a portion (of the surface-side well wall portion) surrounding the valve hole by the centrifugal force of the air valve with a pneumatic pressure detection device. Accordingly, the effect of suppressing vibration of the automotive wheel generated while the automobile is running is further improved as well.

Further, this configuration is suitably used for an automotive w in which a wheel rim has a relatively small rim width (length in the surface-side-back-side direction). More specifically, an automotive wheel for light motor vehicles and small vehicles normally includes a wheel rim with a small rim width, and thus has a small rim diameter (inside diameter of bead seats) and a small well length in the surface-side-back-side direction (axial direction). On the other hand, there is a limit in reducing the size of the air valve with a pneumatic pressure detection device since the pneumatic pressure detection device includes a circuit, a battery, and so forth as discussed above. From what has been described above, it is concerned that the pneumatic pressure detection d Tice of the air valve with pneumatic pressure detection device may not be disposed in the well in an automotive wheel with us/null rim width. In this configuration, however, the well recessed portion in which the back-side portion of the pneumatic pressure detection device can be disposed is provided at a position opposite the valve hole even in the case of a small rim width. Thus, the air valve with a pneumatic pressure detection device can be mounted adequately with the back-side portion of the pneumatic pressure detection device disposed in the well recessed portion.

A second aspect of the present invention provides an automotive wheel including: a wheel rim including surface-side and back-side bead seats that support beads of a tire, and a groove-shaped well formed circumferentially between the surface-side and back-side bead seats; and a wheel disc to be coupled to an axle, the well of the wheel rim being formed by an annular well bottom portion, and surface-side and back-side well wall portions formed continuously with inclination to extend in a surface-side-back-side direction from surface-side and back-side ends, respectively, of the well bottom portion, and an air valve with a pneumatic pressure detection device being mounted to a valve hole formed in the surface-side well wall portion with the pneumatic pressure detection device disposed in the well, in which a well recessed portion that is recessed in a surface-side direction along the well bottom portion is formed at a portion of the surface-side well wall portion of the well at which the valve hole is formed such that a surface-side portion of the pneumatic pressure detection device of the air valve with a pneumatic pressure detection device is disposed in the well recessed portion.

Also with such a configuration, as with the first aspect discussed above, the rigidity of a portion surrounding the valve hole is improved by the well recessed portion formed at a portion where the valve hole is formed. This makes it possible to suppress elastic deformation in the outward direction caused in the portion surrounding the valve hole by the own weight of the air valve with a pneumatic pressure detection device. This makes it possible to suppress vibration generated by rotation of the automotive wheel while the automobile is running, and therefore to demonstrate excellent operation stability, riding comfort, and so forth. With a well recessed portion 61 configured as shown in FIGS. 7 and 9, for example, side wall portions 64, 64 of a well bottom portion 57 can achieve the effect of suppressing elastic deformation in the outward direction of an inclined portion 63 in which a valve hole 59 is formed. This enhances the effect of suppressing elastic deformation in the outward direction the inclined portion 63 (surface-side well wall portion 58a) as described above. Preferably, the side wall portions of the well recessed portion and both side ends of the pneumatic pressure detection device of the air valve with a pneumatic pressure detection device are positioned in proximity to each other in the circumferential direction such that the surface-side portion of the pneumatic pressure detection device is fitted in the well recessed portion.

In this configuration, the pneumatic pressure detection device of the air valve with a pneumatic pressure detection device is provided in the well recessed portion of the surface-side well wall portion. Thus, the pneumatic pressure detection device can be adequately disposed in the well by applying this configuration to an automotive wheel with a small rim width discussed above (for light motor vehicles and small vehicles).

In the automotive wheel according to the first aspect of the present invention, as discussed above, a well recessed portion that is recessed in a back-side direction along the well bottom portion forming the well of the wheel rim is formed at a portion of the back-side well wall portion of the well opposite the valve hole. Thus, elastic deformation in the outward direction caused in a portion surrounding the valve hole by the centrifugal force of the air valve with a pneumatic pressure detection device while the automobile is running can be suppressed by the effect due to the shape of the well recessed portion. Therefore, vibration due to the elastic deformation can be suppressed. Thus, the operation stability, the riding comfort, and so forth of the automobile equipped with the automotive wheel can be improved.

In the automobile wheel discussed above, the well recessed portion of the back-side well wall portion may be formed such that a back-side portion of the pneumatic pressure detection device of the air valve with a pneumatic pressure detection device can be disposed in the well recessed portion. In this case, elastic deformation in the outward direction caused in the portion surrounding the valve hole by the centrifugal force of the air valve with a pneumatic pressure detection device while the automobile is running can be farther suppressed. This further improves the effect of suppressing vibration due to the elastic deformation. Also in the case where such a configuration is applied to an automotive wheel with a small rim width, the air valve with a pneumatic pressure detection device can be mounted adequately with the back-side portion of the pneumatic pressure detection device disposed in the well recessed portion.

In the automotive wheel according to the second aspect of the present invention, as discussed above, a well recessed portion that is recessed in a surface-side direction along the well bottom portion forming the well of the wheel rim is formed at a portion of the surface-side well wall portion forming the well at which the valve hole is formed such that a surface-side portion of the pneumatic pressure detection device of the air valve with a pneumatic pressure detection device is disposed in the well recessed portion. Thus, elastic deformation in the outward direction caused in a portion surrounding the valve hole by the centrifugal force of the air valve with a pneumatic pressure detection device while the automobile is running can be suppressed by the effect due to the shape of the well recessed portion which the valve hole is formed. Therefore, the effect of suppressing vibration due to the elastic deformation is improved. This makes it possible to improve the operation stability, the riding comfort, and so forth of the automobile equipped with the automotive wheel. Also in the case where such a configuration is applied to an automotive wheel with a small rim width, the air valve with a pneumatic pressure detection device can be mounted adequately with the surface-side portion of the pneumatic pressure detection device disposed in the well recessed portion.

### BRIEF DESCRIPTION OF THE DRAWINGS

FIG. 1 is a vertical cross-sectional view of an automotive wheel 1 according to a first embodiment of the present invention.

FIG. 2 is a side view of the automotive wheel 1.

FIG. 3 is a perspective view of a wheel rim 2 forming the automotive wheel 1.

FIG. 4 is an enlarged vertical cross-sectional view showing the attachment of an air valve 100 with a pneumatic pressure detection device to the automotive wheel 1.

FIG. 5 is a side view showing the attachment of an air valve 100 with a pneumatic pressure detection device to an automotive wheel 1 according to a second embodiment.

FIG. 6 is an enlarged vertical cross-sectional view showing the attachment of the air valve 100 with a pneumatic pressure detection device to the automotive wheel 1.

FIG. 7 is a perspective view of a wheel rim 52 forming an automotive wheel 51 according to a third embodiment.

FIG. 8 is a side view showing the attachment of an air valve 100 with a pneumatic pressure detection device to the automotive wheel 51.

FIG. 9 is an enlarged vertical cross-sectional view showing the attachment of the air valve 100 with a pneumatic pressure detection device to the automotive wheel 51.

FIG. 10 is a side view showing the attachment of an air valve 100 with a pneumatic pressure detection device to an automotive wheel 71 according to a fourth embodiment.

FIG. 11 is an enlarged vertical cross-sectional view showing the attachment of the air valve 100 with a pneumatic pressure detection device to the automotive wheel 71.

### BEST MODE FOR CARRYING OUT THE INVENTION

Embodiments of the present invention will be described in detail with reference to the accompanying drawings.

### First Embodiment

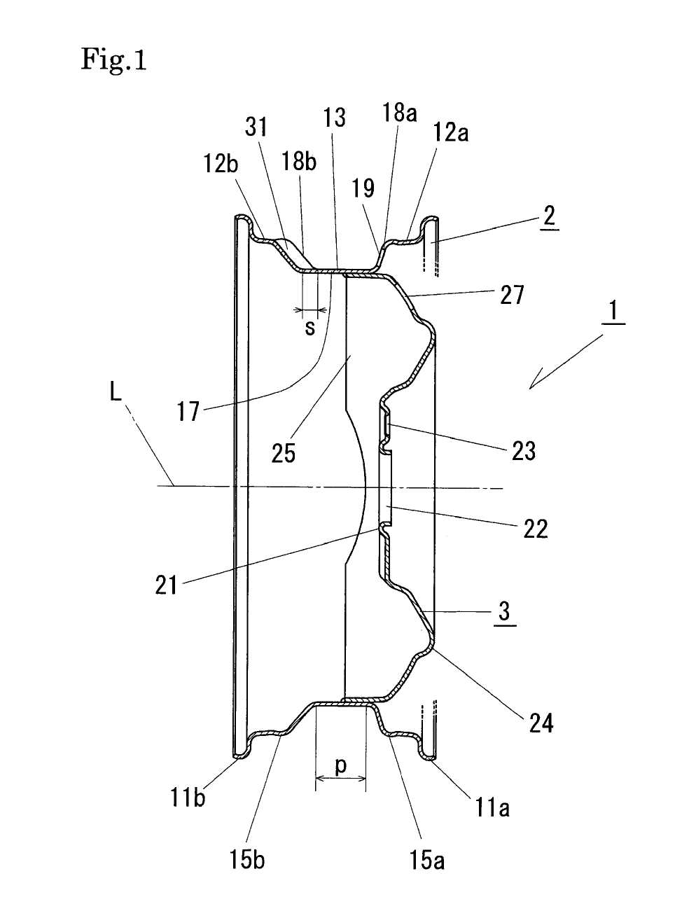

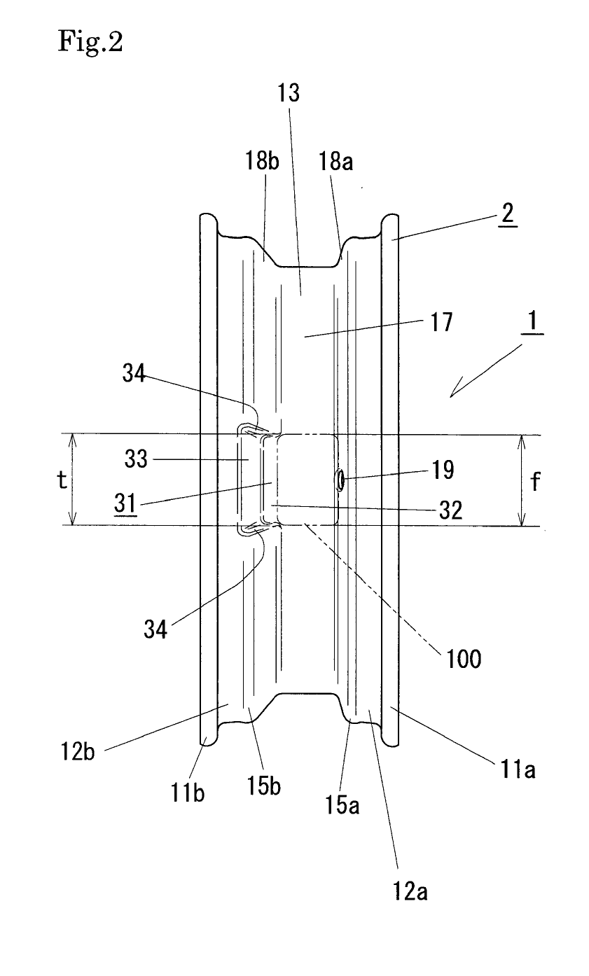

FIGS. 1 and 2 are a vertical cross-sectional view and a side view, respectively, of an automotive wheel 1 according to a first embodiment. The automotive wheel 1 has a so-called well-fitting configuration in which a disc flange 25 of a wheel disc 3 is fitted inside a well 13 of a wheel rim 2 so that the well 13 and the disc flange 25 are integrated with each other by fillet welding. The wheel rim 2 and the wheel disc 3 are each obtained by shaping a flat steel plate. The automotive wheel 1 according to the first embodiment is a two-piece steel wheel.

In the embodiment, the direction from a back-surface side toward an aesthetic-surface side of the wheel disc 3 is defined as a surface-side direction, and the direction opposite to the surface-side direction is defined as a back-side direction. In addition, the direction toward a center axis L of the automotive wheel 1 along the radial direction of the wheel which is orthogonal to the center axis L is defined as an inward direction, and the direction opposite to the inward direction is defined as an outward direction.

The wheel rim 2 is shaped into a cylinder having different cross sections. Rim flanges 11a, 11b are formed circumferentially at surface-side and back-side opening end edges, respectively, of the wheel rim 2 to support respective side walls of a tire (not shown) from a side. Surface-side and back-side bead seats 12a, 12b are formed continuously with the rim flanges 11a, 11b, respectively, to allow respective beads of the tire to be seated on the surface-side and back-side bead seats 12a, 12b. Further, the groove-shaped well 13 dented in the inward direction is formed circumferentially between the surface-side bead seat 12a and the back-side bead seat 12b so that the tire can be mounted easily by dropping the beads of the tire into the well 13. The well 13 and the surface-side bead seat 12a are formed continuously via a surface-side hump portion 15a bulged in the outward direction. In addition, a back-side hump portion 15b bulged in the outward direction is provided between the well 13 and the back-side bead seat 12b. The surface-side and back-side hump portions 15a, 15b prevent the beads of the mounted tire from slipping off from the surface-side and back-side bead seats 12a, 12b while the automobile is running.

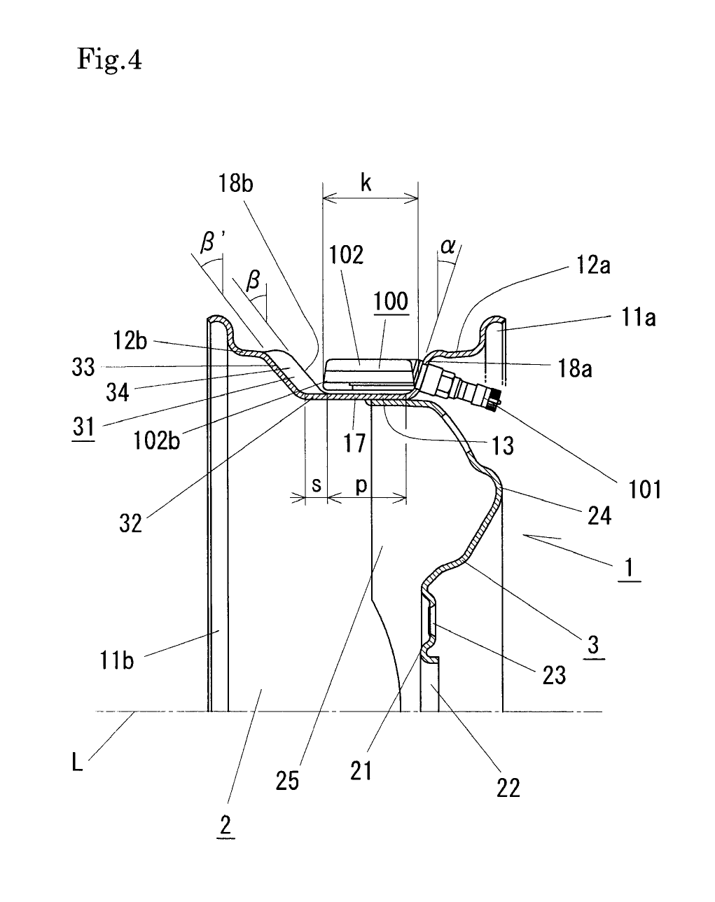

The well 13 is formed by an annular well bottom portion 17 extending along the center axis L of the wheel rim 2, a surface-side well wall portion 18a that rises up with inclination in the surface-side direction from the surface-side end of the well bottom portion 17, and a back-side well wall portion 18b that rises up with inclination in the back-side direction from the back-side end of the well bottom portion 17. The well bottom portion 17 and each of the surface-side and back-side well wall portions 18a, 18b are formed continuously in a smoothly curved manner. An inclination angle α (see FIG. 4) of the surface-side well wall portion 18a with respect to the radial direction orthogonal to the center axis L is set in accordance with the “Japan Automobile Tyre Manufacturers Association 2009”, which prescribes α≧10° according to the size of the wheel rim. Meanwhile, an inclination angle β (see FIG. 4) of the back-side well wall portion 18b is normally set to an angle equivalent to or larger than the inclination angle α, not specifically prescribed. The surface-side well wall portion 18a is formed continuously with the surface-side hump portion 15a. The back-side well wall portion 18b is formed continuously with the back-side hump portion 15b.

Further, a valve hole 19 is formed by drilling in the surface-side well wall portion 18a of the well 13. An air valve 100 with a pneumatic pressure detection device to be discussed later is to be attached to the valve hole 19.

The wheel rim 2 is obtained by shaping a flat rectangular steel plate with predetermined dimensions. More specifically, the flat rectangular steel plate is rolled with its shorter sides butting against each other, and the shorter sides are butt-joined by upset butt welding to be formed into a cylinder body (not shown). Thereafter, the cylinder body is subjected to rolling, in which the cylinder body is pressed by predetermined dies from the inside and the outside, to be shaped into a wheel rim of a desired shape. Then, the valve hole 19 is formed by drilling at a predetermined position in the circumferential direction. The wheel rim 2 may be formed from a flat rectangular steel plate by a method known in the art, which is not described in detail herein.

The wheel disc 3 is generally in the shape of a disc. The wheel disc 3 includes a hub mounting portion 21 having a hub hole 22 opening in the center, and an annular hat portion 24 bulged in the surface-side direction from the outer peripheral edge of the hub mounting. portion 21. The annular disc flange 25 is provided to extend in the back-side direction from the outer peripheral edge of the hat portion 24. A plurality of bolt holes 23 each having a nut seat (not shown) are formed by drilling around the hub hole 22 of the hub mounting portion 21 at equal intervals on the same circumference. The hub mounting portion 21, the hat portion 24, and the disc flange 25 are provided concentrically with each other around the center axis L of the wheel disc 3.

The wheel disc 3 is obtained by pressing a flat steel plate. More specifically, a flat generally square steel plate is formed into a saucer shape in which a circular recess is formed at the center, then the hub mounting portion 21 and the hat portion 24 are formed by drawing, and the bolt holes 23 and ornamental holes 27 are formed by drilling. Additionally, the disc flange 25 is formed by restriking to complete the shaping of the wheel disc 3. The processes of shaping the wheel disc 3 may be performed in a conventional manner, and therefore are not described in detail herein.

The automotive wheel 1 according to the first embodiment includes a so-called 5° drop center (5° DC) rim as the wheel rim 2. More specifically, the automotive wheel 1 is an automotive wheel of a 13×4.00 B type (or a 13×4 J type) for use in light motor vehicles, small vehicles, and so forth. In this type of automotive wheel, the wheel rim 2 has a rim width of 4 inches, and the well bottom portion 17 of the well 13 has a surface-side-back-side direction width p of about 30 mm. The surface-side-back-side direction width p of the well bottom portion 17 corresponds to the width of a portion of the well bottom portion 17 extending substantially in parallel with the center axis L, and does not include the width of curved portions (not shown) formed continuously with the surface-side and back-side well wall portions 18a, 18b in a smoothly curved manner.

The air valve 100 with a pneumatic pressure detection device mounted to the automotive wheel 1 will be described. As shown in FIG. 4, the air valve 100 with a pneumatic pressure detection device is formed by a valve portion 101 and a pneumatic pressure detection device 102. The air valve 100 with a pneumatic pressure detection device is mounted to the wheel rim 2 by inserting the valve portion 101 through the valve hole 19 of the well 13 from the outside of the wheel rim 2 for fixation. The pneumatic pressure detection device 102 is disposed in the well 13 with the air valve 100 with a pneumatic pressure detection device mounted to the wheel rim 2.

Male threads (not shown) are formed on the outer peripheral surface of the base portion of the valve portion 101. After the valve portion 101 is inserted through the valve hole 19, a predetermined mounting nut (not shown) is threaded onto the male threads from inside the surface-side well wall portion 18a to press a portion surrounding the valve hole 19 for fixation. The pneumatic pressure detection device 102 includes a generally rectangular housing (not shown) gently curved along the circumferential direction of the well 13, and a pressure sensing element (not shown) that senses the pneumatic pressure in the transmission device (not shown) that transmits a voltage signal indicating the pressure sensed by the pressure sensing element to a reception device mounted to the automobile, a battery, and so forth, which are disposed in the housing. The pressure sensing element may output a voltage signal indicating distortion caused by a pressure applied to a sensor portion to allow detection of the pressure on the basis of the magnitude of the voltage signal. The battery is not easily replaceable, and thus a battery with a relatively long life (for example, 10 years) may be used. With the valve portion 101 fixed to the portion surrounding the valve hole 19 and with the automotive wheel 1 not rotating, the pneumatic pressure detection device 102 is in contact with the well bottom portion 17 of the well 13. With the valve portion 101 fixed to the portion surrounding the valve hole 19 and with the automotive wheel 1 rotating, however, the pneumatic pressure detection device 102 is in no contact with the well bottom portion 17 of the well 13, and therefore the air valve 100 with a pneumatic pressure detection device is supported by only the portion of the surface-side well wall portion 18a surrounding the valve hole 19.

In the air valve 100 with a pneumatic pressure detection device according to the embodiment, the pneumatic pressure detection device 102 has a surface-side-back-side direction width k (see FIG. 4) of about 35 mm. The air valve 100 with the thus-sized pneumatic pressure detection device is relatively small among various types of air valves with a pneumatic pressure detection device.

The key elements of the present invention will be described below.

In the configuration according to the first embodiment, as shown in FIGS. 1 to 4, a well recessed portion 31 that is recessed in the back-side direction along the well bottom portion 17 is provided at the back-side well wall portion 18b of the well 13. The well recessed portion 31 is formed at a position opposite the valve hole 19 of the surface-side well wall portion 18a.

The well recessed portion 31 is formed by an extended bottom portion 32 extended in the back-side direction along the well bottom portion 17, an inclined portion 33 formed continuously with inclination to extend in the back-side direction from an end edge of the extended bottom portion 32, and side wall portions 34, 34 that rise up in the outward direction from both side edges of the extended bottom portion 32. As shown in FIG. 4, the inclined portion 33 of the well recessed portion 31 has an inclination angle β′ with respect to the radial direction orthogonal to the center axis L. In the case of the first embodiment, the inclination angle β′ is set to be substantially equal to the inclination angle β. While the inclination angle β′ may be set to an angle larger or smaller than the inclination angle β as appropriate, it is necessary to set the inclination angle β′ in accordance with the various dimensions of the wheel rim 2 such that the back-side end of the inclined portion 33 should be formed continuously with, or positioned in the surface-side direction with respect to, the surface-side end of the back-side bead seat 12b.

The well recessed portion 31 may be shaped by pressing before or after drilling of the valve hole 19 in the process of shaping the wheel rim 2 discussed above. Therefore, the side wall portions 34, 34 of the well recessed portion 31 are formed to be expanded in the outward direction.

Further, as shown in FIGS. 2 and 4, a circumferential width t of the well recessed portion 31 is set such that a back-side portion 102b of the pneumatic pressure detection device 102 of the air valve 100 with a pneumatic pressure detection device can be fitted in the well recessed portion 31. That is, the circumferential width t of the well recessed portion 31 is slightly larger than a circumferential width f of the pneumatic pressure detection device 102.

As discussed above, the automotive wheel 1 according to the first embodiment includes the wheel rim 2 in which the well bottom portion 17 of the well 13 has a surface-side-back-side direction width p of about 30 mm. The pneumatic pressure detection device 102 of the air valve 100 with a pneumatic pressure detection device has a surface-side-back-side direction width b of about 35 mm. Because the surface-side-back-side direction width k of the pneumatic pressure detection device 102 corresponds to the width of the pneumatic pressure detection device 102 from the boundary with the valve portion 101 to the back-side end and the pneumatic pressure detection device 102 is disposed in no contact with the well bottom portion 17, the air valve 100 with a pneumatic pressure detection device can be disposed in the well 13 as shown FIG. 4 even if the surface-side-back-side direction width k is slightly larger than the surface-side-back-side direction width p of the well bottom portion 17. The pneumatic pressure detection device 102 is not disposed in the well recessed portion 31.

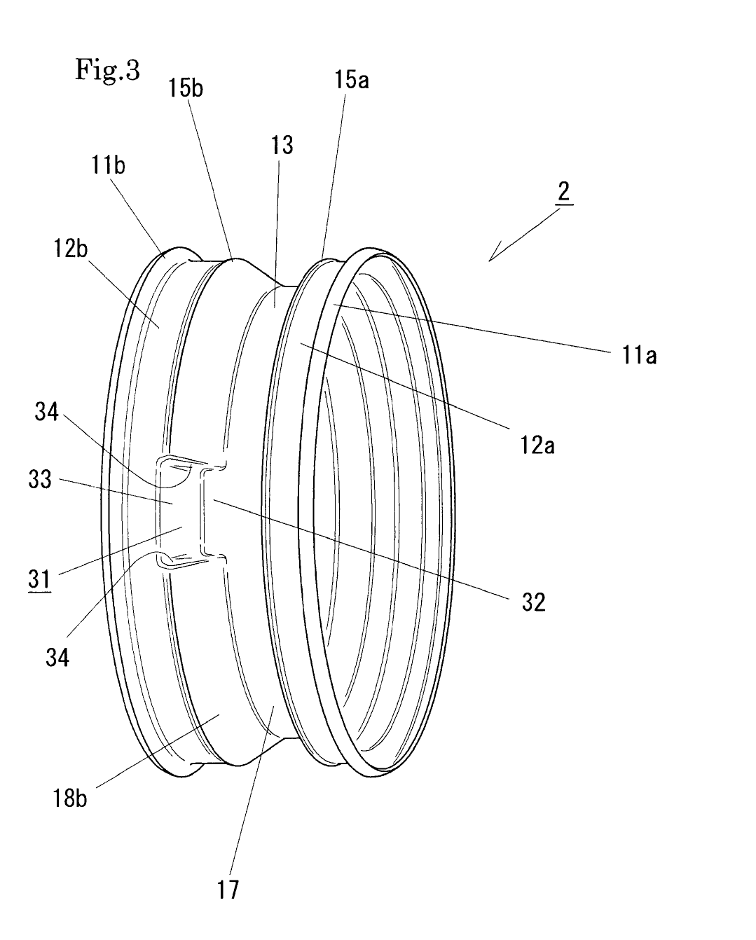

The wheel rim 2 according to the first embodiment has a small rim width, and the well recessed portion 31 is formed in the back-side well wall portion 18b. Thus, the back-side hump portion 15b provided between the back-side well wall portion 18b and the back-side bead seat 12b is interrupted in the circumferential direction by the well recessed portion 31 as shown in FIGS. 2 and 3. The circumferential width t of the well recessed portion 31 is sufficiently smaller compared to the circumferential length of the back-side hump portion 15b. Thus, even the back-side hump portion 15b which is partially interrupted in the circumferential direction can achieve the effect of preventing the beads of the tire from slipping off while the automobile is running. Empirically, the necessity for the surface-side hump portion 15a is greater than that for the back-side hump portion 15b, and it would be difficult for the beads of the tire to slip off if the back-side hump portion were not provided. However, the beads of the tire would easily slip off if the surface-side hump portion were not provided. Therefore, the configuration in which the back-side hump portion 15b is interrupted by the well recessed portion 31 does not significantly affect the effect of preventing the beads of the tire from slipping off.

After the air valve 100 with a pneumatic pressure detection device is attached to the automotive wheel 1 according to the first embodiment, a tire is mounted to the automotive wheel 1, and then the automotive wheel 1 is attached. to a predetermined automobile. When the automotive wheel 1 rotates while the automobile is running, a centrifugal force is generated by the own weight of the air valve 100 with a pneumatic pressure detection device so that the portion surrounding the valve hole 19, at which the air valve 100 with a pneumatic pressure detection device is fixed, is pulled in the outward direction. Therefore, the portion of the surface-side well wall portion 18a, which is inclined in the surface-side direction, surrounding the valve hole 19 is urged to be elastically deformed in the outward direction, with a point around the surface-side end of the surface-side well wall portion 18a serving as the fulcrum. This is because the surface-side well wall portion 18a is inclined and therefore relatively easily deformed by application of the centrifugal force in the outward direction. In the first embodiment, however, the well recessed portion 31 is formed at a position opposite the valve hole 19, and thus the rigidity in the inward-outward direction is improved by the effect due to the shape of the well recessed portion 31. More specifically, the side wall portions 34, 34 of the well recessed portion 31 are provided to extend along the surface-side-back-side direction, and thus the well recessed portion 31 demonstrates the effect of suppressing elastic deformation in the outward direction of the portion surrounding the valve hole 19. Further, the side wall portions 34, 34 are preferably provided to extend along the direction of a line normal to the well recessed portion 31, which improves the effect of suppressing the elastic deformation.

A depth s of the well recessed portion 31 in the back-side direction is set such that the effect discussed above is demonstrated by the effect due to the shape of the well recessed portion 31. This is because the size (area) of the side wall portions 34, 34 is determined by the depth s, and thus the depth s is related to the rigidity in the outward direction provided by the side wall portions 34, 34.

By forming the well recessed portion 31 at a portion of the back-side well wall portion 18b opposite the valve hole 19, it is possible to suppress elastic deformation in the outward direction of the portion surrounding the valve hole 19, at which the air valve 100 with a pneumatic pressure detection device is fixed, due to the centrifugal force of the air valve 100 with a pneumatic pressure detection device. This makes it possible to suppress vibration generated in the automotive wheel 1 while the automobile is running, and therefore to improve the operation stability, the riding comfort, and so forth of the automobile.

### Second Embodiment

In a second embodiment, the automotive wheel 1 has a smaller rim width compared to that according to the first embodiment discussed above. Specifically, the automotive wheel 1 is an automotive wheel of a 13×3.50 B type (or a 13×3½ J type). The automotive wheel 1 according to the second embodiment has the same configuration as that according to the first embodiment except for having a smaller rim width. Thus, like constituent elements are denoted by like reference numerals, and therefore are not described herein.

In the second embodiment, the wheel rim 2 has a rim width of 3.5 inches, and the well bottom portion 17 of the well 13 has a surface-side-back-side direction width p of about 22 mm. The air valve 100 with a pneumatic pressure detection device has the same configuration and size as those according to the first embodiment.

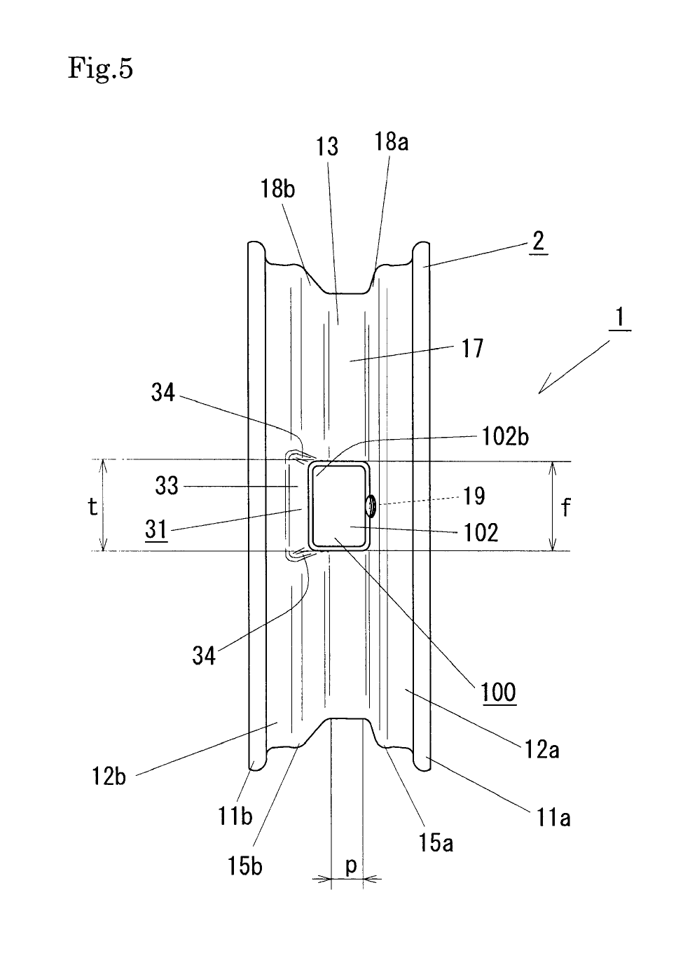

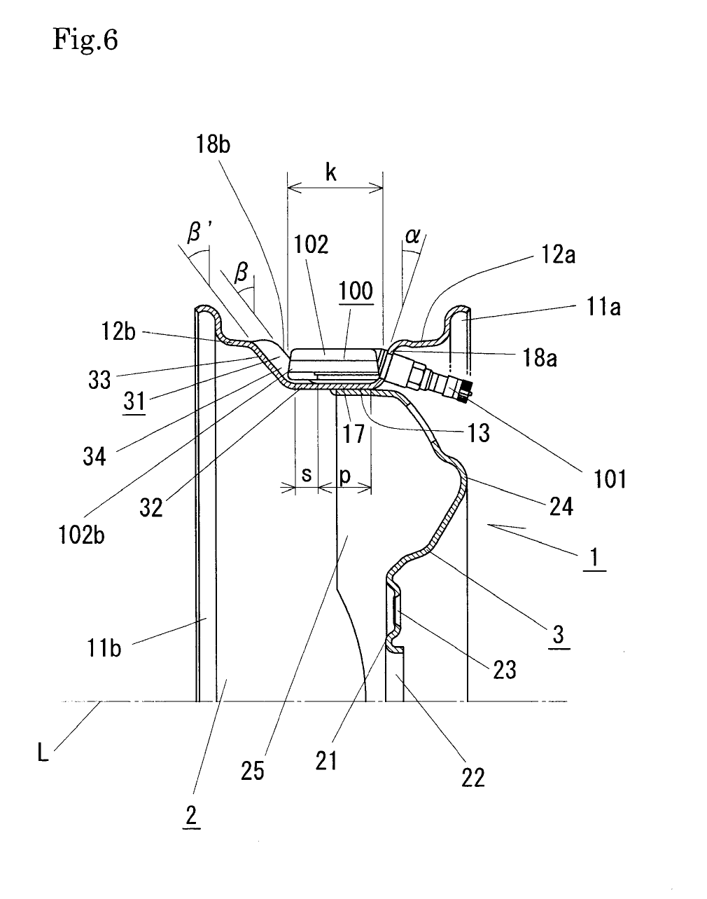

In the wheel rim 2 according to the second embodiment, as shown in FIGS. 5 and 6, the well recessed portion 31 is provided in the back-side well wall portion 18b such that the back-side portion 102b of the pneumatic pressure detection device 102 is fitted in the well recessed portion 31. That is, the circumferential width t of the well recessed portion 31 is slightly larger than the circumferential width f of the pneumatic pressure detection device 102. Because the well bottom portion 17 of the well 13 of the wheel rim 2 has a small surface-side-back-side direction width p, the back-side portion 102b of the pneumatic pressure detection device 102 is fitted in the well recessed portion 31 in the case where the air valve 100 with a pneumatic pressure detection device is mounted to the valve hole 19. This allows the air valve 100 with a pneumatic pressure detection device to be disposed in the well 13 even if the wheel rim 2 has a small rim width as in the second embodiment. Therefore, the air valve 100 with a pneumatic pressure detection device can be easily mounted to the automotive wheel 1 with a small rim width for use in light motor vehicles, small vehicles, and so forth. This achieves the effect of keeping the pneumatic pressure of the tire adequate at all times, which accordingly improves the fuel efficiency, the safety, and so forth.

The depth s of the well recessed portion 31 in the back-side direction is set in consideration of the surface-side-back-side direction width p of the well 13 and the surface-side-back-side direction width k of the pneumatic pressure detection device 102 such that the air valve 100 with a pneumatic pressure detection device can be disposed in the well 13.

Also in the second embodiment, further, the well recessed portion 31 is formed at a position opposite the valve hole 19. Thus, elastic deformation in the outward direction caused in the portion surrounding the valve hole 19 by the own weight of the air valve 100 with a pneumatic pressure detection device can be suppressed as in the first embodiment discussed above. This makes it possible to suppress vibration generated in the automotive wheel 1 while the automobile is running, and therefore to demonstrate excellent operation stability. In this way, the second embodiment also achieves the same effect as that achieved by the first embodiment discussed above.

### Third Embodiment

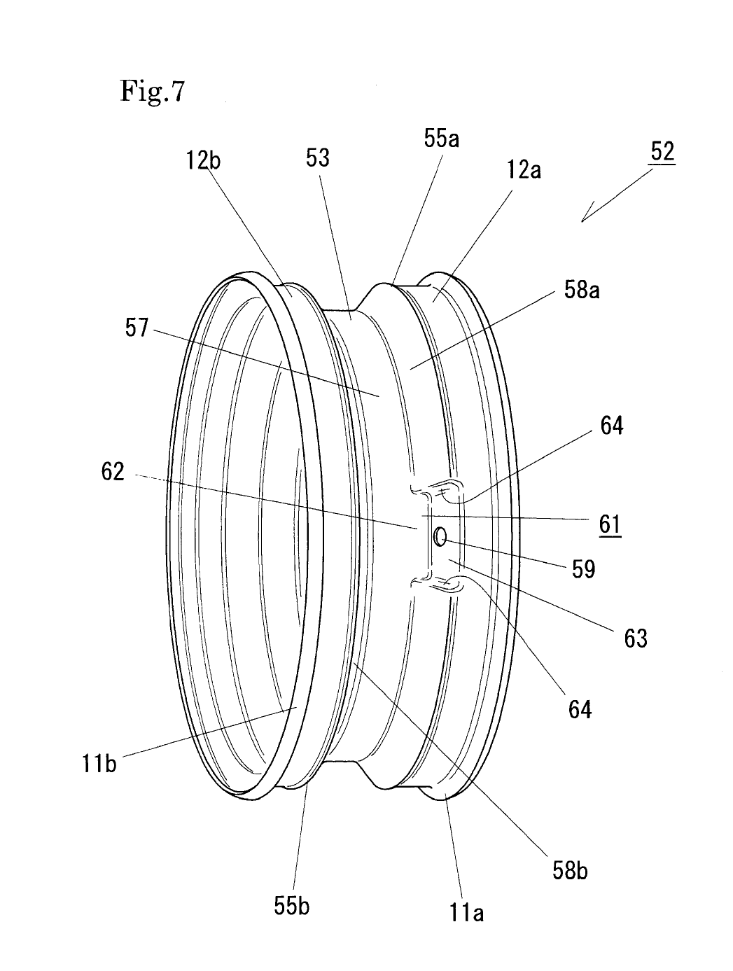

In an automobile wheel 51 according to a third embodiment, as shown in FIGS. 7 to 9, a well recessed portion 61 is formed in a surface-side well wail portion 58a of a wheel rim 52. The wheel rim 52 has the same configuration as that according to the first embodiment discussed above except that the well recessed portion 61 is provided in the surface-side well wall portion 58a of a well 53. Thus, like constituent elements are denoted by like reference numerals, and therefore are not described herein. The wheel disc 3 has the same configuration as that according to the first embodiment discussed above. Thus, like constituent elements are denoted by like reference numerals, and therefore are not described herein.

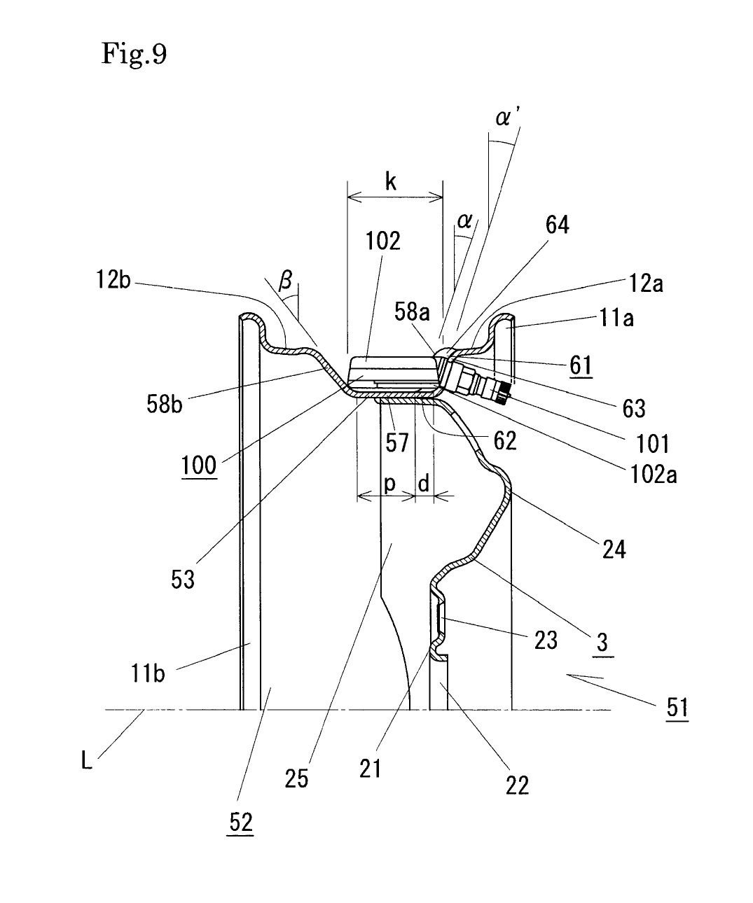

In the wheel rim 52, the well recessed portion 61 is formed to be dented in the surface-side direction at a portion of the surface-side well wall portion 58a of the well 53 at which a valve hole 59 is formed. The well recessed portion 61 is formed by an extended bottom portion 62 extended in the surface-side direction along a well bottom portion 57 of the well 53, an inclined portion 63 formed continuously with inclination to extend in the surface-side direction from an end edge of the extended bottom portion 62, and side wall portions 64, 64 that rise up in the outward direction from both side edges of the extended bottom portion 62. As shown FIG. 9, the inclined portion 63 of the well recessed portion 61 has an inclination angle α′ with respect to the radial direction orthogonal to the center axis L. In the case of the third embodiment, the inclination angle α′ is set to be substantially equal to the inclination angle α of the surface-side well wall portion 58a. The side wall portions 64, 64 are formed to be expanded in the outward direction as in the first embodiment discussed above.

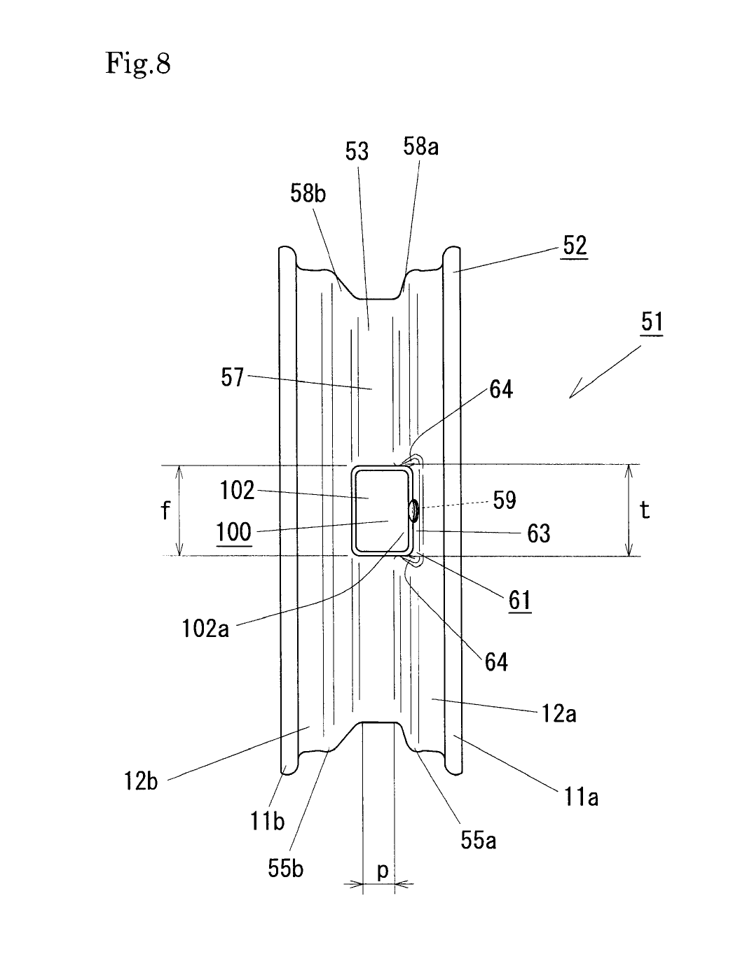

Further, the well recessed portion 61 is configured such that a surface-side portion 102a of the pneumatic pressure detection device 102 of the air valve 100 with a pneumatic pressure detection device is fitted in the well recessed portion 61. That is, as shown in FIG. 8, the circumferential width t of the well recessed portion 61 is slightly larger than the circumferential width f of the pneumatic pressure detection device 102. In the well recessed portion 61, the length of extension of the extended bottom portion 62 and the inclination angle α′ of the inclined portion 63 are set such that the surface-side end of the inclined portion 63 is formed continuously with the surface-side bead seat 12a. As shown in FIGS. 7 and 8, while a back-side hump portion 55b is provided over the circumferential direction, a surface-side hump portion 55a is interrupted in the circumferential direction by the well recessed portion 61. The circumferential width t of the well recessed portion 61 is sufficiently smaller compared to the circumferential length of the surface-side hump portion 55a. Thus, even the surface-side hump portion 55a which is partially interrupted in the circumferential direction can demonstrate the effect of preventing the beads of the tire from slipping off while the automobile is running.

The wheel rim 52 according to the third embodiment can be shaped in the shaping. process discussed above, by shaping the well recessed portion 61 by pressing after the rolling, and thereafter forming the valve hole 19 in the inclined portion 63 of the well recessed portion 61 by drilling. A back-side well wall portion 58b of the well 53 is formed with inclination at an inclination angle of β over the circumferential direction.

The automobile wheel 51 according to the third embodiment is an automotive wheel of a 13×3.50 B type, which is the same as that according to the second embodiment discussed above. In addition, the air valve 100 with a pneumatic pressure detection device has the same configuration size, and shape as those according to the first embodiment discussed above.

In the automotive wheel 51, as shown in FIGS. 8 and 9, the valve portion 101 of the air valve 100 with a pneumatic pressure detection device is inserted through the valve hole 59 for attachment with the surface-side portion 102a of the pneumatic pressure detection device 102 fitted in the well recessed portion 61 of the surface-side well wall portion 58a. This allows the pneumatic pressure detection device 102 of the air valve 100 with a pneumatic pressure detection device to be disposed in the well 53. Also in the third embodiment, the wheel rim 52 has a small rim width as that according to the second embodiment discussed above, and the surface-side-back-side direction width p of the well bottom portion 57 of the well 53 is small. Therefore, the surface-side portion 102a of the pneumatic pressure detection device 102 is disposed in the well recessed portion 61 in the case where the air valve 100 with a pneumatic pressure detection device is mounted to the valve hole 59. This allows the air valve 100 with a pneumatic pressure detection device to be disposed in the well 53 even if the wheel rim 52 has a small rim width as in the second embodiment discussed above. Therefore, the air valve 100 with a pneumatic pressure detection device can be easily mounted to the automotive wheel 51 with a small rim width for use in light motor vehicles, small vehicles, and so forth. This achieves the effect of keeping the pneumatic pressure of the tire adequate at all times, which accordingly improves the fuel efficiency, the safety, and so forth.

In the third embodiment, further, the valve hole 59 is provided in the inclined portion 63 of the well recessed portion 61. Thus, elastic deformation of the inclined portion 63 in the inward-outward direction can be suppressed further effectively by the side wall portions 64, 64 formed continuously with the inclined portion 63. This enhances the effect of suppressing elastic deformation in the outward direction caused in the portion surrounding the valve hole 59 (inclined portion 63) by the own weight of the air valve 100 with a pneumatic pressure detection device while the automobile is running, which demonstrates high operation stability by suppressing vibration of the automotive wheel 51.

A depth d of the well recessed portion 61 in the surface-side direction is set such that the inclined portion 63 can demonstrate the effect of suppressing the elastic deformation. The well recessed portion 61 according to the third embodiment is formed in the surface-side well wall portion 58a. Thus, the inclined portion 63 has an excellent effect of suppressing the elastic deformation, compared to that according to the first and second embodiments discussed above. Therefore, the depth d of the well recessed portion 61 can be set to be smaller compared to the depth s of the well recessed portion 31 according to the first and second embodiments.

### Fourth Embodiment

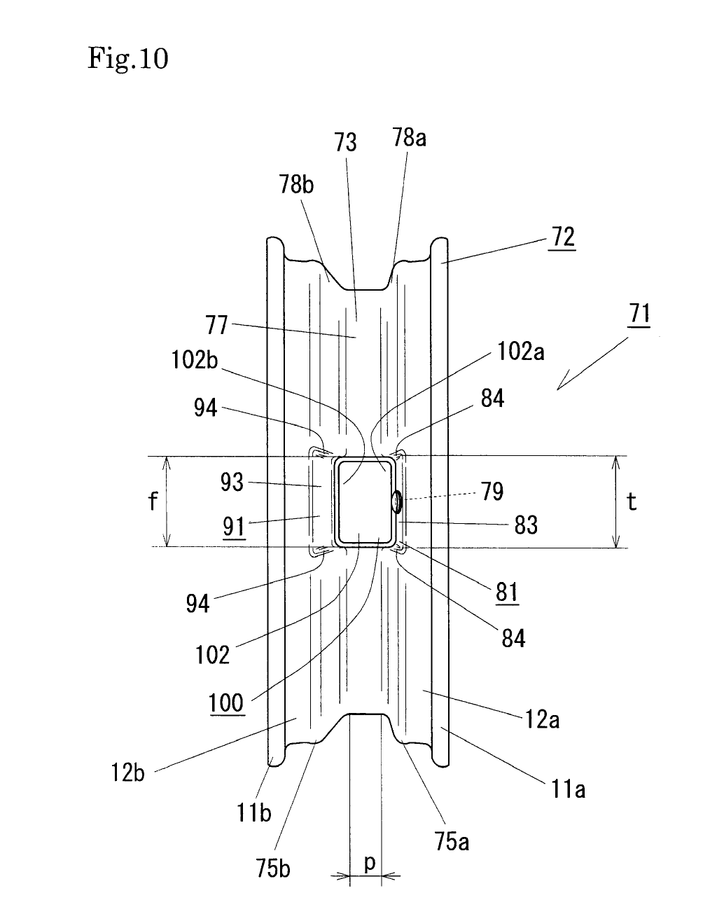

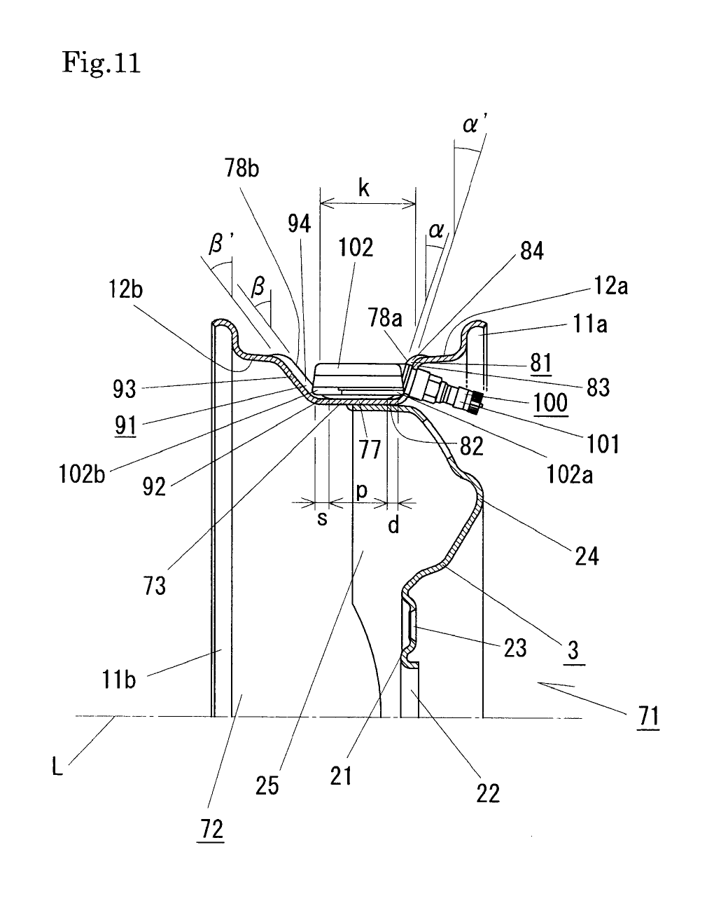

In an automotive wheel 71 according to a fourth embodiment, as shown in FIGS. 10 and 11, a wheel rim 72 includes a surface-side well recessed portion 81 in a surface-side well wall portion 78a, and a back-side well recessed portion 91 in a back-side well wall portion 78b. The wheel disc 3 has the same configuration as that according to the first embodiment discussed above. Thus, like constituent elements are denoted by like reference numerals, and therefore are not described herein.

The surface-side well recessed portion 81 is formed to be dented in the surface-side direction at a portion of the surface-side well wall portion 78a of a well 73 at which a valve hole 79 is formed. The back-side well recessed portion 91 is formed to be dented in the back-side direction at a portion of the back-side well wall portion 78b opposite the surface-side well recessed portion 81. The surface-side well recessed portion 81 has a circumferential width t set such that the surface-side portion 102a of the pneumatic pressure detection device 102 of the air valve 100 with a pneumatic pressure detection device is fitted in the surface-side well recessed portion 81. The back-side well recessed portion 91 has the same circumferential width t as the surface-side well recessed portion 81 set such that the back-side portion 102b of the pneumatic pressure detection device 102 is fitted in the back-side well recessed portion 91. The surface-side well recessed portion 81 and the back-side well recessed portion 91 are provided at the same circumferential position as each other.

The surface-side well recessed portion 81 is formed by an extended bottom portion 82 extended in the surface-side direction along a well bottom portion 77 of the well 73, an inclined portion 83 formed continuously with inclination to extend in the surface-side direction from an end edge of the extended bottom portion 82, and side wall portions 84, 84 that rise up in the outward direction from both side edges of the extended bottom portion 82. The inclined portion 83 of the surface-side well recessed portion 81 has an inclination angle α′ with respect to the radial direction orthogonal to the center axis L. As in the case of the third embodiment, the inclination angle α′ is set to be substantially equal to the inclination angle α of the surface-side well wall portion 78a. The back-side well recessed portion 91 is formed by an extended bottom portion 92 extended in the back-side direction along the well bottom portion 77 of the well 73, an inclined portion 93 formed continuously with inclination to extend in the back-side direction from an end edge of the extended bottom portion 92, and side wall portions 94, 94 that rise up in the outward direction from both side edges of the extended bottom portion 92. The inclined portion 93 of the back-side well recessed portion 91 has an inclination angle β with respect to the radial direction orthogonal to the center axis L. As in the case of the first embodiment, the inclination angle β′ is set to be substantially equal to the inclination angle β of the back-side well wall portion 78b. The side wall portions 84, 84 of the surface-side well recessed portion 81 and the side wall portions 94, 94 of the back-side well recessed portion 91 are also formed to be expanded in the outward direction as in the first to third embodiments discussed above.

In the wheel rim 72 according to the fourth embodiment, a surface-side hump portion 75a is interrupted in the circumferential direction by the surface-side well recessed portion 81 as in the third embodiment, and a back-side hump portion 75b is interrupted in the circumferential direction by the back-side well recessed portion 91 as in the first embodiment. The circumferential width t of the surface-side well recessed portion 81 and the back-side well recessed portion 91 is sufficiently smaller compared to the circumferential length of the surface-side hump portion 75a and the back-side hump portion 75b. Thus, even the surface-side hump portion 75a and the back-side hump portion 75b which are partially interrupted in the circumferential direction can demonstrate the effect of preventing the beads of the tire from slipping off while the automobile is running.

The automobile wheel 71 according to the fourth embodiment is an automotive wheel of a 13×3.50 B type, which is the same as that according to the second embodiment discussed above. In addition, the air valve 100 with a pneumatic pressure detection device has the same configuration, size, and shape as those according to the first embodiment discussed above.

In the wheel rim 72 according to the fourth embodiment, the length of the surface-side well recessed portion 81 in the surface-side-back-side direction is set to be smaller compared to that according to the third embodiment. In the case where the air valve 100 with a pneumatic pressure detection device is mounted to the valve hole 79 of the wheel rim 72, the surface-side portion 102 of the pneumatic pressure detection device 102 is fitted in the surface-side well recessed portion 81, and the back-side portion 102b of the pneumatic pressure detection device 102 is fitted in the back-side well recessed portion 91. This allows the pneumatic pressure detection device 102 of the air valve 100 with a pneumatic pressure detection device to be disposed in the well 73 even if the wheel rim 72 has a small rim width. Therefore, the air valve 100 with a pneumatic pressure detection device can be easily mounted to a light motor vehicle or the like to achieve the effect of keeping the pneumatic pressure of the tire adequate as in the second and third embodiments discussed above.

Also in the fourth embodiment, elastic deformation in the outward direction caused in the portion surrounding the valve hole 79 (inclined portion 83) by the own weight of the air valve 100 with a pneumatic pressure detection device while the automobile is running can be suppressed by the side wall portions 84, 84 of the surface-side well recessed portion 81 and the side wall portions 94, 94 of the back-side well recessed portion 91. Therefore, vibration of the automotive wheel 71 generated while the automobile is running can be suppressed to demonstrate the effect of improving the operation stability and so forth as in the first to third embodiments discussed above.

The depth d of the surface-side well recessed portion 81 in the surface-side direction is set to be smaller compared to that in the case of the third embodiment discussed above, and the depth s of the back-side well recessed portion 91 in the surface-side direction is set to be smaller compared to that in the case of the first and second embodiments discussed above. This is because both the effects due to the shapes of the surface-side well recessed portion 81 and the back-side well recessed portion 91 are achieved. Even if the depths d, s are set in this way, the pneumatic pressure detection device 102 can be disposed in the well 73 as described above.

In the second to fourth embodiments discussed above, a wheel rim of the 13×3.50 B type is used. However, a wheel rim of the 134.00 B type such as that according to the first embodiment may also be used. In the case where the fourth embodiment is applied to a wheel rim with a relatively large rim width, the back-side portion of the pneumatic pressure detection device of the air valve with a pneumatic pressure detection device may not be disposed in the back-side well recessed portion. The present invention may also be applied to a wheel rim with a further larger rim width to achieve the same effect. Conversely, the present invention may also be applied to a wheel rim with a further smaller rim width, in which case the pneumatic pressure detection device is partially fitted in at least one of the surface-side and back-side well recessed portions. This allows the air valve with a pneumatic pressure detection device to be easily mounted to a light motor vehicle or the like to achieve the effect obtained by sensing the pneumatic pressure of the tire.

Since the first embodiment discussed above is applied to a wheel rim with a relatively large rim width, the back-side portion of the pneumatic pressure detection device of the air valve with a pneumatic pressure detection device is not disposed in the back-side well recessed portion. Therefore, the circumferential width t of the well recessed portion may be set to be smaller compared to the circumferential width f of the pneumatic pressure detection device. Likewise, in the case where the fourth embodiment is applied to a wheel rim with a large rim width, the pneumatic pressure detection device is not disposed in the back-side well recessed portion. Thus, the circumferential width t of the back-side well recessed portion may be small. Even in a configuration in which the pneumatic pressure detection device is not disposed in the well recessed portion formed in the back-side well wall portion (and the back-side well recessed portion), the circumferential width t is preferably set to be substantially the same as the circumferential width f of the pneumatic pressure detection device. Specifically, the circumferential width t is preferably 0.8 or more and 1.2 or less times the circumferential width f.

In the first to fourth embodiments discussed above, the back-side hump portion is provided between the back-side bead seat and the well. However, the back-side hump portion may not be provided. As discussed above, the back-side hump portion prevents the back-side bead of the tire from slipping off. Empirically, however, it would be difficult for the back-side bead of the tire to slip off even if the back-side hump portion were not provided. Thus, even with no back-side hump portion provided, the automotive wheel can function adequately, and further the effect of the present invention can be achieved adequately as well.

In the first to fourth embodiments discussed above, the present invention is applied to an automotive wheel of a well-fitting type in which a disc flange of a wheel disc is fitted inside a well of a wheel rim so that the well and the disc flange are welded to each other. However, the present invention may also be applied to other types of automotive wheels. Specifically, the present invention may be applied to automotive wheels of a bead-fitting type in which a wheel disc is fitted inside a surface-side bead seat of a wheel rim, a flange-fitting type in which a wheel disc is fitted inside a surface-side flange of a wheel rim, and a full-face type. In any type of automotive wheels, a well recessed portion can be formed by pressing after a wheel rim is shaped by rolling.

In the first to fourth embodiments discussed above, the wheel rim and the wheel disc are shaped from a flat steel plate. However, the present invention may also be applied to those shaped from a flat aluminum alloy plate, a flat titanium alloy plate, or a flat magnesium alloy plate to achieve the same effect. A flat aluminum alloy plate, a flat titanium alloy plate, and a flat magnesium alloy plate can also be shaped by the same process as that for a flat steel plate. Alternatively, one of the wheel rim and the wheel disc may be shaped from a flat steel plate and the other may be shaped from a flat aluminum alloy plate, a flat titanium alloy plate, or a flat magnesium alloy plate to achieve the same effect.

In the first to fourth embodiments discussed above, a well recessed portion (a surface-side well recessed portion and a back-side well recessed portion) is provided in an automotive wheel in which the wheel rim and the wheel disc are shaped from a flat steel plate. However, the present invention is not limited thereto, and the well recessed portion (the surface-side well recessed portion and the back-side well recessed portion) may be provided in an automotive wheel shaped by casting (or forging) from an aluminum alloy, a magnesium alloy, or a titanium alloy. In the case where an automotive wheel with a well recessed portion is to be manufactured by casting (or forging), the casting die (forging die) for manufacturing the automotive wheel may be provided in advance with a feature for forming the well recessed portion, or the well recessed portion may be formed by cutting after the casting (forging).

The present invention is not limited to the embodiments discussed above, and may be modified appropriately within the scope and spirit of the present invention.

### DESCRIPTION OF REFERENCE NUMERALS

1, 51, 71: automotive wheel
2, 52, 72: wheel rim
3: wheel disc
12a: surface-side bead seat
12b: back-side bead seat
13, 53, 73: well
17, 57, 77: well bottom portion
18a, 58a, 78a: surface-side well wall portion
18b, 58b, 78b: back-side well wall portion
19, 59, 79: valve hole
31, 61: well recessed portion
81: surface-side well recessed portion
91: back-side well recessed portion
100: air valve with pneumatic pressure detection device
102: pneumatic pressure detection device
102a: surface-side portion (of pneumatic pressure detection device)
102b: back-side portion (of pneumatic pressure detection device)

1. An automotive wheel comprising:
a wheel rim including surface-side and back-side bead seats that support beads of a tire, and a groove-shaped well formed circumferentially between the surface-side and back-side bead seats; and
a wheel disc to be coupled to an axle,
the well of the wheel rim being formed by an annular well bottom portion, and surface-side and back-side well wall portions formed continuously with inclination to extend in a surface-side-back-side direction from surface-side and back-side ends, respectively, of the well bottom portion, and
an air valve with a pneumatic pressure detection device being mounted to a valve hole formed in the surface-side well wall portion with the pneumatic pressure detection device disposed in the well,
wherein a well recessed portion that is recessed in a back-side direction along the well bottom portion is formed at a portion of the back-side well wall portion of the well opposite the valve hole.

2. The automotive wheel according to claim 1, wherein the well recessed portion formed in the back-side well wall portion of the well is formed such that a back-side portion of the pneumatic pressure detection device of the air valve with a pneumatic pressure detection device can be disposed in the well recessed portion.

3. An automotive wheel comprising:
a wheel rim including surface-side and back-side bead seats that support beads of a tire, and a groove-shaped well formed circumferentially between the surface-side and back-side bead seats; and
a wheel disc to be coupled to an axle,
the well of the wheel rim being formed by an annular well bottom portion, and surface-side and back-side well wall portions formed continuously with inclination to extend in a surface-side-back-side direction from surface-side and back-side ends, respectively, of the well bottom portion, and
an air valve with a pneumatic pressure detection device being mounted to a valve hole formed in the surface-side well wall portion with the pneumatic pressure detection device disposed in the well,
wherein a well recessed portion that is recessed in a surface-side direction along the well bottom portion is formed at a portion of the surface-side well wall portion of the well at which the valve hole is formed such that a surface-side portion of the pneumatic pressure detection device of the air valve with a pneumatic pressure detection device is disposed in the well recessed portion.
